(19) United States
(12) Patent Application Publication
(10) Pub. No.: US 2026/0171016 A1
(43) Pub. Date: Jun. 18, 2026

(54) DISPLAY DEVICE

(71) Applicant: SONY SEMICONDUCTOR SOLUTIONS CORPORATION, KANAGAWA (JP)

(72) Inventor: TAKAYUKI SAKAGUCHI, KANAGAWA (JP)

(21) Appl. No.: 19/126,662

(22) PCT Filed: Oct. 31, 2023
(86) PCT No.: PCT/JP2023/039187

§ 371 Date: May 2, 2025

(30) Foreign Application Priority Data
Nov. 9, 2022 (JP) 2022-179849

(51) Int. Cl. G09G 3/3233

(52) U.S. Cl. CPC G09G 3/3233; G09G 2300/0852; G09G 2310/08; G09G 2320/0209; G09G 2320/0233

(57) ABSTRACT

To improve display quality. A display device includes: a pixel including a light emitting element; a plurality of signal lines each of which is connected to a plurality of the pixels; and a signal line drive section including a reference voltage generation section that generates a reference voltage whose voltage level changes with time, the signal line drive section supplying the reference voltage to the plurality of signal lines to offset a fluctuation in a voltage of one end of the light emitting element due to a change in a voltage of each of the signal lines.

### TECHNICAL FIELD

Embodiments according to the present disclosure relate to a display device.

### BACKGROUND ART

In a display device, a method of driving a pixel circuit by a voltage follower circuit is used. However, this method has a problem that power consumption increases. In order to reduce the power consumption, for example, a method of inputting a voltage signal of a ramp waveform to a signal line of a plurality of pixel circuits and sampling a desired voltage (signal voltage) for each pixel may be used (See Patent Document 1).

### CITATION LIST

### Patent Document

Patent Document 1: Japanese Patent Application Laid-Open No. 2005-234020

### SUMMARY OF THE INVENTION

### Problems to be Solved by the Invention

However, in the above-described method of sampling the voltage, there is a possibility that deterioration in display quality such as vertical crosstalk occurs.

Therefore, the present disclosure provides a display device capable of improving display quality.

### Solutions to Problems

In order to solve the above problem, according to the present disclosure, there is provided a display device including:
a pixel including a light emitting element;
a plurality of signal lines each of which is connected to a plurality of the pixels; and
a signal line drive section including a reference voltage generation section that generates a reference voltage whose voltage level changes with time, the signal line drive section supplying the reference voltage to the plurality of signal lines to offset a fluctuation in a voltage of one end of the light emitting element due to a change in a voltage of each of the signal lines.

The signal line drive section may supply the reference voltage to the plurality of signal lines such that an average value of fluctuations in a voltage at one end of the light emitting element due to a change in a voltage of each of the signal lines decreases every first predetermined period.

The reference voltage generation section may generate an offset voltage whose voltage level changes with time, and may generate the reference voltage after generating the offset voltage, and
the offset voltage and the reference voltage may change with time in directions opposite to each other.

The signal line drive section may supply a precharge voltage at which a voltage level of each of the signal lines becomes a first level, supply an offset voltage whose voltage level changes with time after supply of the precharge voltage, and generate the reference voltage after generation of the offset voltage,
the offset voltage and the reference voltage may change with time in the same direction, and
the signal line drive section may extend a period from start of supply of the precharge voltage to start of supply of the offset voltage.

The signal line drive section may maintain a voltage of each of the signal lines at the first level for a second predetermined period from when the voltage of the signal line becomes the first level to when the offset voltage is supplied.

The reference voltage generation section may delay start of generation of the offset voltage.

The signal line drive section may include a voltage maintenance section that maintains a voltage of each of the signal lines at the first level for a second predetermined period from when the voltage of the signal line becomes the first level to when the offset voltage is supplied.

The signal line drive section may slow a change in the precharge voltage.

The reference voltage generation section may generate the precharge voltage that changes slower than a predetermined speed.

The signal line drive section may include a delay section that slows a change in the precharge voltage.

The reference voltage generation section may generate the reference voltage that changes in a reverse direction every third predetermined period.

The third predetermined period may include one horizontal period.

The reference voltage generation section may generate an offset voltage whose voltage level changes with time, and generate the reference voltage after generation of the offset voltage, and
the offset voltage and the reference voltage may change with time in the same direction.

The signal line drive section may slow a change in a voltage of each of the signal lines up to a second level that is a voltage level at start of supply of the reference voltage.

The reference voltage generation section may generate an

offset voltage whose voltage level changes with time, and generate the reference voltage after generation of the offset voltage, and
before generation of the offset voltage, the reference voltage generation section may generate a voltage that brings a voltage level of each of the signal lines to a third level that is a voltage level substantially same as a voltage at an end of a change of the reference voltage.

A voltage at one end of the light emitting element may fluctuate due to a change in a voltage of each of the signal lines via a parasitic capacitance between the signal line and the one end of the light emitting element.

The signal line drive section may further include a plurality of switches connected between the reference voltage generation section and each of the plurality of signal lines, and
the switches may be turned on or off at timing according to a luminance value of the pixel.

### BRIEF DESCRIPTION OF DRAWINGS

FIG. 1 is a block diagram illustrating a schematic configuration of a display device according to a first embodiment of the present disclosure.

FIG. 2 is a circuit diagram illustrating an example of an internal configuration of a pixel circuit according to the first embodiment.

FIG. 3 is a circuit diagram illustrating an example of a configuration of a signal line drive section according to the first embodiment.

FIG. 4 is a diagram illustrating an example of display of a pixel according to the first embodiment.

FIG. 5 is a timing chart illustrating an example of operation of each of pixels according to the first embodiment and a first comparative example.

FIG. 6 is a diagram illustrating an example of display of each of display devices according to the first embodiment and the first comparative example.

FIG. 7 is a circuit diagram illustrating an example of an internal configuration of a pixel circuit according to a modification example of the first embodiment.

FIG. 8 is a diagram illustrating an example of display of each of display devices according to the modification example of the first embodiment and a second comparative example.

FIG. 9 is a timing chart illustrating an example of operation of a pixel according to a second embodiment.

FIG. 10 is a circuit diagram illustrating an example of a configuration of a signal line drive section according to a modification example of the second embodiment.

FIG. 11 is a timing chart illustrating an example of operation of a pixel according to a third embodiment.

FIG. 12 is a circuit diagram illustrating an example of a configuration of a signal line drive section according to a first modification example of the third embodiment.

FIG. 13 is a circuit diagram illustrating an example of a configuration of a signal line drive section according to a second modification example of the third embodiment.

FIG. 14 is a circuit diagram illustrating an example of a configuration of a signal line drive section according to a third modification example of the third embodiment.

FIG. 15 is a timing chart illustrating an example of operation of a pixel according to a fourth embodiment.

FIG. 16 is a timing chart illustrating an example of operation of a pixel according to a fifth embodiment.

FIG. 17 is a timing chart illustrating an example of operation of a pixel according to a sixth embodiment.

FIG. 18 is a circuit diagram representing a configuration example of a pixel.

FIG. 19 is a circuit diagram representing a configuration example of a pixel.

FIG. 20 is a circuit diagram representing a configuration example of a pixel.

FIG. 21 is a circuit diagram representing a configuration example of a pixel.

FIG. 22 is a circuit diagram representing a configuration example of a pixel.

FIG. 23 is a circuit diagram representing a configuration example of a pixel.

FIG. 24 is a circuit diagram representing a configuration example of a pixel.

FIG. 25 is a circuit diagram representing a configuration example of a pixel.

FIG. 26 is a perspective view representing an external appearance of a head mounted display of Application example 1.

FIG. 27 is a perspective view representing an external appearance of a head mounted display of Application example 2.

FIG. 28A is a front view representing an external appearance of a digital still camera of Application example 3.

FIG. 28B is a rear view representing an external appearance of the digital still camera of Application example 3.

FIG. 29 is a perspective view representing an external appearance of a television apparatus of Application example 4.

FIG. 30 is a perspective view representing an external appearance of a smartphone of Application example 5.

FIG. 31A is a diagram illustrating an internal state of a vehicle as viewed from a rear side to a front side of the vehicle of Application example 6.

FIG. 31B is a diagram illustrating an internal state of the vehicle as viewed from an oblique rear side to an oblique front side of the vehicle of Application example 6.

### MODE FOR CARRYING OUT THE INVENTION

Hereinafter, embodiments of a display device will be described with reference to the drawings. Although main configuration parts of the display device will be mainly described below, the display device may have a configuration part or function that is not illustrated or described. The following description is not intended to exclude configuration parts and functions that are not illustrated or described.

### First Embodiment

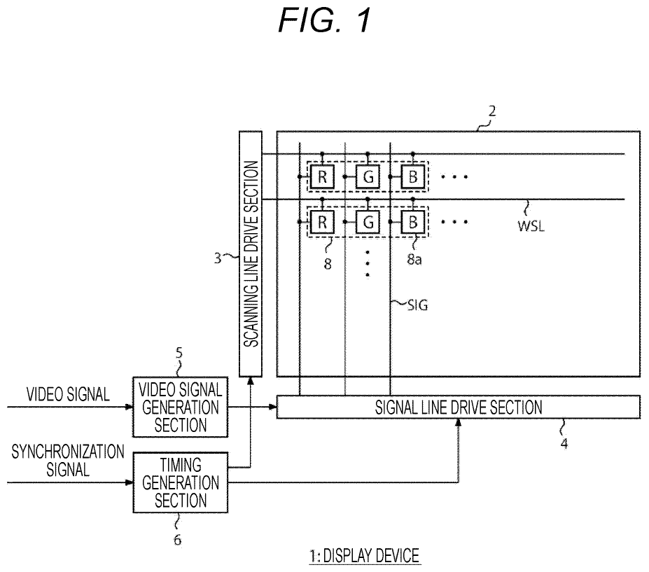

FIG. 1 is a block diagram illustrating a schematic configuration of a display device 1 according to a first embodiment of the present disclosure. The display device 1 of FIG. 1 can be exemplified by an organic EL display device, a liquid crystal display device, a plasma display device, and the like. Among these display devices, the organic EL display device uses an organic EL element (hereinafter, organic light emitting device (OLED)) that uses electroluminescence of an organic material and uses a phenomenon of emitting light when an electric field is applied to an organic thin film as a light emitting element (electro-optical element) of a pixel.

The display device 1 of FIG. 1 includes a pixel array section 2, a scanning line drive section 3, a signal line drive section 4, a video signal processing section 5, and a timing generation section 6.

The pixel array section 2 includes a plurality of pixels 8 arranged in each of a row direction and a column direction. Each pixel 8 has a plurality of subpixels 8a. The plurality of subpixels 8a includes, for example, three subpixels 8a of red, blue, and green. The plurality of subpixels 8a may include subpixels 8a of colors other than red, blue, and green (for example, white). In the present specification, the subpixels 8a may be collectively referred to as a pixel 8.

Each of the subpixel 8a in the pixel 8 includes a display element and a pixel circuit as described later. The display element is, for example, an OLED. Note that the display element may be a liquid crystal element or a self-luminous element other than the OLED.

The pixel array section 2 includes a plurality of scanning lines WSL arranged for each pixel group in the row direction and a plurality of signal lines SIG arranged for each pixel group in the column direction. The pixel 8 is provided near each intersection of the scanning line WSL and the signal line SIG. In the present specification, the row direction may be referred to as a horizontal line direction, and the column direction may be referred to as a vertical line direction.

The scanning line drive section 3 sequentially drives the plurality of scanning lines WSL. The signal line drive section 4 drives the plurality of signal lines SIG in the horizontal line direction at the same timing in synchronization with the timing at which the scanning line WSL drives each horizontal line. Driving the signal line SIG means supplying a gradation signal corresponding to each signal line SIG.

The video signal processing section 5 performs predetermined signal processing on a video signal supplied from the outside (for example, a processor) to generate the gradation signal. The predetermined signal processing is, for example, processing such as gamma correction and overdrive correction.

The timing generation section 6 supplies a timing control signal to the scanning line drive section 3 and the signal line drive section 4 on the basis of a synchronization signal supplied from the outside, and operates the scanning line drive section 3 and the signal line drive section 4 in synchronization.

The number of pixels in the pixel array section 2 in FIG. 1 is not particularly limited. In the high-definition display device 1 having a large number of pixels, the scanning line drive section 3 may be arranged on both end sides in the horizontal line direction. Furthermore, in order to drive the plurality of signal lines SIG in the horizontal line direction separately, a plurality of signal line drive sections 4 may be provided.

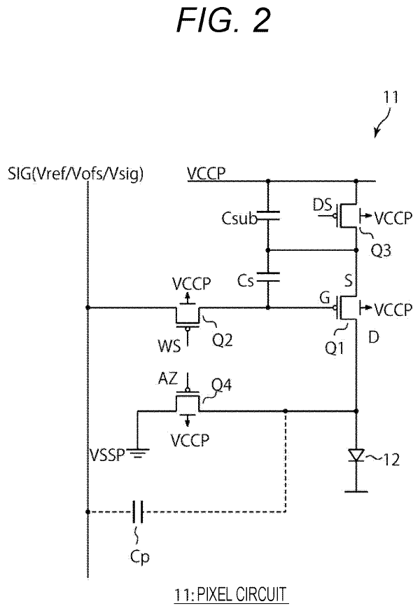

FIG. 2 is a circuit diagram illustrating an example of an internal configuration of a pixel circuit 11 according to the first embodiment. FIG. 2 illustrates an example of the pixel circuit 11 that controls light emission of an OLED 12 in a case where the OLED 12 is used as a display element. The pixel circuit 11 of FIG. 2 includes four transistors Q1 to Q4 called 4Tr2C and two capacitors (a first capacitor Cs and a second capacitor Csub). In the present specification, the four transistors Q1 to Q4 in the pixel circuit 11 are referred to as a drive transistor Q1, a sampling transistor Q2, a drive scan transistor Q3, and an auto-zero transistor Q4. The drive transistor Q1 may be abbreviated as a Drv transistor Q1, the sampling transistor Q2 may be referred to as a WS transistor Q2, the drive scan transistor Q3 may be referred to as a DS transistor Q3, and the auto-zero transistor Q4 may be referred to as an AZ transistor Q4.

In the pixel circuit 11 of FIG. 2, an example in which the Drv transistor Q1, the WS transistor Q2, the DS transistor Q3, and the AZ transistor Q4 are configured by P-type metal-oxide-semiconductor (MOS) transistors is illustrated, but as will be described later, the Drv transistor Q1, the WS transistor Q2, the DS transistor Q3, and the AZ transistor Q4 may be configured by N-type MOS transistors.

The DS transistor Q3 and the Drv transistor Q1 are cascode-connected between the power supply voltage node VCCP and the anode of the OLED 12. The WS transistor Q2 is connected between the signal line SIG and the gate of the Drv transistor Q1. In FIG. 2, the signal input to the gate of the WS transistor Q2 is referred to as a WS signal, and the signal input to the gate of the DS transistor Q3 is referred to as a DS signal. A gradation signal and an offset signal are supplied to the signal line SIG at different timings.

The AZ transistor Q4 is connected between the anode of the OLED 12 and a ground voltage node VSSP. An AZ signal is supplied to a gate of the AZ transistor Q4. In a case where the AZ transistor Q4 is a P-type MOS transistor, when the AZ signal is low, a source-drain current of the Drv transistor Q1 passes through the AZ transistor Q4 and flows to the ground voltage node VSSP. Therefore, while the AZ transistor Q4 is on, an increase in an anode voltage of the OLED 12 is suppressed, and the current does not flow through the OLED 12.

The first capacitor Cs is connected between the gate and the source of the Drv transistor Q1. Furthermore, a second capacitor Csub is connected between the source and the drain of the DS transistor Q3. That is, the first capacitor Cs and the second capacitor Csub are connected in series between the power supply voltage node VCCP and the gate of the Drv transistor Q1. The first capacitor Cs may be referred to as a pixel capacitance, and the second capacitor Csub may be referred to as an auxiliary capacitance.

The first capacitor Cs and the second capacitor Csub are, for example, metal-insulator-metal (MIM) capacitors. In this case, for example, at least one electrode of the capacitor is disposed in a wiring layer.

A cathode of the OLED 12 is fixed to a predetermined voltage (for example, a ground voltage).

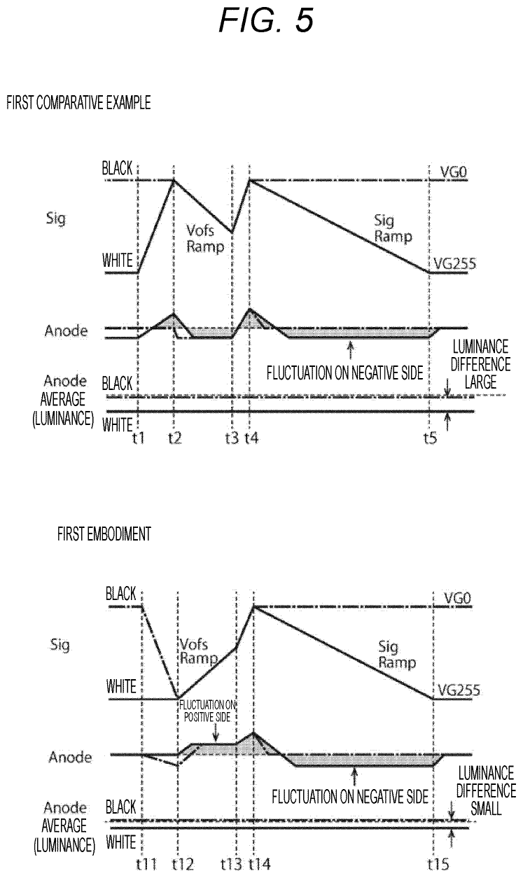

Here, FIG. 2 illustrates a parasitic capacitance Cp connected between the anode of the OLED 12 and the signal line SIG. When the signal line SIG is written, the voltage at one end (anode) of the OLED 12 fluctuates according to a change in the voltage of the signal line SIG via the parasitic capacitance Cp. The OLED 12 emits light with a light emission luminance according to an anode voltage. Therefore, the fluctuation in the anode voltage leads to a fluctuation in the luminance of the pixel 8. Note that the fluctuation in the luminance will be described later with reference to FIG. 5.

Next, the Signal Line Drive Section 4 Will Be Described.

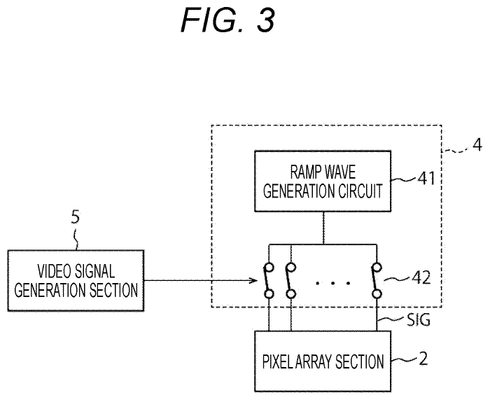

FIG. 3 is a circuit diagram illustrating an example of a configuration of the signal line drive section 4 according to the first embodiment.

The signal line drive section 4 includes a ramp wave generation circuit 41 and a switch 42.

The ramp wave generation circuit (reference voltage generation section) 41 generates a reference voltage whose voltage level changes with time. The reference voltage includes a signal ramp voltage. The signal ramp voltage is supplied to the plurality of signal lines SIG. The signal ramp voltage is not limited to a ramp wave voltage, and may be any voltage that changes at a substantially constant slope with time.

The ramp wave generation circuit 41 generates an offset voltage (offset ramp voltage) whose voltage level changes with time, and generates a signal ramp voltage after generating the offset ramp voltage (see FIG. 5).

A plurality of the switches 42 is connected between the ramp wave generation circuit 41 and each of the plurality of signal lines SIG. The plurality of switches 42 is provided for each signal line SIG. The switch 42 is turned on or off at timing according to the luminance value of the pixel 8. The switch 42 is turned off at a timing based on the signal from the video signal generation section in the middle of the ramp signal. As a result, the voltage of the signal line SIG is held at a desired gradation voltage VGx (x=0 to 255) according to the luminance value. The gradation voltage VG0 corresponds to black, and the gradation voltage VG255 corresponds to white.

Furthermore, as will be described later with reference to FIG. 5, the signal line drive section 4 supplies the reference voltage to the plurality of signal lines SIG so as to offset the fluctuation in the anode voltage of the OLED 12 due to the change in the voltage of the signal line SIG. This can lead to an improvement in display quality.

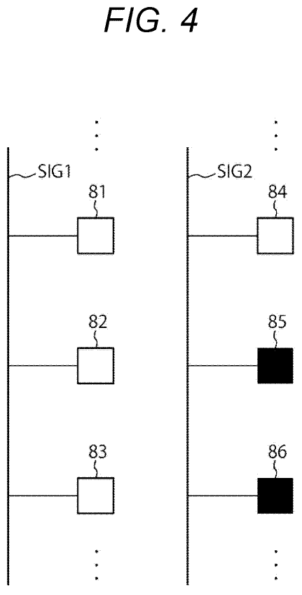

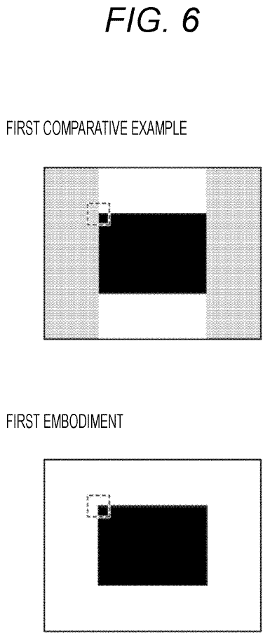

FIG. 4 is a diagram illustrating an example of display of the pixel 8 according to the first embodiment. FIG. 4 illustrates some of the pixels 81 to 86 extracted (see the broken-line frame in FIG. 6).

Each of the plurality of signal lines SIG is connected to the plurality of pixels 8.

The pixels 81 to 83 are connected to the signal line SIG1. The pixels 84 to 86 are connected to the signal line SIG2. In the example illustrated in FIG. 4, the pixels 81 to 84 display white, and the pixels 85 and 86 display black.

The signal line drive section 4 supplies voltages to the pixels 81 to 83 displaying white color in this order for each 1H (one horizontal period) via the signal line SIG1, for example. The signal line drive section 4 supplies voltages to the pixels 84 displaying white and the pixels 85 and 86 displaying black in this order for each 1H (one horizontal period) via the signal line SIG2, for example.

Next, the voltage supplied to the signal line SIG will be described.

FIG. 5 is a timing chart illustrating an example of operation of each of the pixels 8 according to the first embodiment and the first comparative example. The left side of FIG. 5 illustrates the operation of the pixel 8 according to the first comparative example. The right side of FIG. 5 illustrates the operation of the pixel 8 according to the first embodiment.

FIG. 5 illustrates an operation in 1H. The timing chart of FIG. 5 illustrates the voltage of the signal line SIG, the anode voltage, and the average value (luminance) of the anode voltage in 1H in order from the top.

As described with reference to FIG. 2, the anode voltage illustrated in the middle stage of the timing chart fluctuates according to the change in the voltage of the signal line SIG illustrated in the upper stage of the timing chart depending on the parasitic capacitance Cp. Note that the anode voltage is also affected by the Drv transistor Q1. Since the gate-source voltage Vgs of the Drv transistor Q1 is determined, the anode voltage fluctuates so as to be balanced. Therefore, as illustrated in FIG. 5, the fluctuation of the anode voltage is different from the change of the voltage of the signal line SIG.

As illustrated in FIG. 5, in the first comparative example, the offset ramp voltage (Vofs Ramp) and the signal ramp voltage (Sig Ramp) change with time in the same direction. The offset ramp voltage and the signal ramp voltage change from a high side to a low side.

First, a case where the pixel 8 in the first comparative example displays white will be described.

First, before time t1, the voltage of the signal line SIG is the gradation voltage VG255.

Next, at time t1, the signal line drive section 4 performs offset precharge. The offset precharge is a precharge before the offset ramp voltage is supplied. Therefore, the voltage of the signal line SIG increases.

Next, at time t2, the voltage of the signal line SIG reaches the gradation voltage VG0, and the signal line drive section 4 supplies the offset ramp voltage.

Next, at time t3, the signal line drive section 4 terminates the supply of the offset ramp voltage and performs signal precharge. The signal precharge is a precharge before the signal ramp voltage is supplied. Therefore, the voltage of the signal line SIG increases.

Next, at time t4, the voltage of the signal line SIG reaches the gradation voltage VG0, and the signal line drive section 4 supplies the signal ramp voltage. Therefore, the voltage of the signal line SIG decreases. In a case where the pixel 8 displays white, the switch 42 maintains the on state during the supply of the signal ramp voltage.

Next, at time t5, the voltage of the signal line SIG becomes the gradation voltage VG255. Thereafter, the next operation of 1H is performed.

Next, a case where the pixel 8 according to the first comparative example displays black will be described.

First, from before time t1 to time t2, the voltage of the signal line SIG is the gradation voltage VG0.

In the period from time t2 to time t4, the voltage of the signal line SIG changes substantially similarly to the voltage of the signal line SIG in a case where the pixel 8 displays white.

In a period from time t4 to time t5, the voltage of the signal line SIG remains at the gradation voltage VG0. This is because in a case where the pixel 8 displays black, the switch 42 illustrated in FIG. 3 is turned off at time t4.

In the first comparative example illustrated in FIG. 5, in a case where the pixel 8 displays white, the anode voltage fluctuates to the positive side near time t2 due to the offset precharge, then fluctuates to the negative side due to the offset ramp voltage, fluctuates to the positive side near time t4 due to the signal precharge, and then fluctuates to the negative side due to the signal ramp voltage. On the other hand, in a case where the pixel 8 displays black, the anode voltage fluctuates to the negative side due to the offset ramp voltage, and fluctuates to the positive side near time t4 due to the signal precharge. In most of the period from time t4 to time t5, the fluctuation of the anode voltage is almost zero.

In a case where the pixel 8 displays white in the period from time t4 to time t5, the anode voltage continues to be affected by the parasitic capacitance Cp. Therefore, the anode voltage remains fluctuated on the negative side for a long period, and the average value (integrated value) of the anode voltage greatly decreases. When the decrease in the average value of the anode voltage is large, the decrease in luminance is large. On the other hand, in a case where the pixel 8 displays black, the decrease in the average value of the anode voltage is small. Therefore, the difference in the average value (luminance) of the anode voltage is large between white and black.

Furthermore, in FIG. 4, the number of pixels 81 to 83 connected to the signal line SIG1 and displaying white is larger than the number of pixels 84 connected to the signal line SIG2 and displaying white. In the signal line SIG1, the voltage is lowered by the supply of the signal ramp voltage by the number of pixels 81 to 83. Since the decrease in the voltage of the signal line SIG leads to the decrease in the anode voltage of the pixel 8 via the parasitic capacitance Cp, the influence of the decrease in the luminance of the plurality of pixels 8 commonly connected to the signal line SIG1 further increases.

FIG. 6 is a diagram illustrating an example of display of each of the display devices 1 according to the first embodiment and the first comparative example. Note that the left side of FIG. 6 illustrates an example of display of the display device 1 according to the first comparative example corresponding to the left side of FIG. 5. The right side of FIG. 6 illustrates an example of display of the display device 1 according to the first embodiment corresponding to the right side of FIG. 5.

FIG. 6 illustrates an example of a case where black is displayed at the central portion of the pixel array section 2 and white is displayed at the outer peripheral portion of the pixel array section 2. Furthermore, the broken-line frame in FIG. 6 indicates the region illustrated in FIG. 4.

As illustrated in the first comparative example of FIG. 6, the white color in the region corresponding to the signal line SIG1 is darker than the white color in the region corresponding to the signal line SIG2. Therefore, in the first comparative example, a luminance difference (vertical crosstalk) occurs. This is because the larger the number of pixels 8 displaying white, the larger the decrease in the anode voltage via the parasitic capacitance Cp.

Therefore, in the first embodiment, the signal line drive section 4 supplies the reference voltage to the plurality of signal lines SIG so as to offset the fluctuation in the voltage of the anode of the OLED 12 due to the change in the voltage of the signal line SIG. As a result, it is possible to suppress a decrease in the anode voltage in a case where the pixel 8 displays white.

More specifically, the signal line drive section 4 performs the signal ramp voltage on the plurality of signal lines SIG such that the average value of the fluctuation in the voltage of the anode of the OLED 12 due to the change in the voltage of the signal line SIG decreases every first predetermined period. In the first embodiment, the first predetermined period is 1H.

As illustrated in FIG. 5, in the first embodiment, the offset ramp voltage (Vofs Ramp) and the signal ramp voltage (Sig Ramp) change with time in directions opposite to each other. The offset ramp voltage changes from a low side to a high side. Note that the signal ramp voltage changes from a high side to a low side similarly to the first comparative example.

First, a case where the pixel 8 according to the first embodiment displays white will be described.

First, from before time t11 to time t12, the voltage of the signal line SIG is the gradation voltage VG255.

Next, at time t12, the signal line drive section 4 supplies the offset ramp voltage. Therefore, the voltage of the signal line SIG increases.

Next, at time t13, the signal line drive section 4 terminates the supply of the offset ramp voltage and performs signal precharge. Therefore, the voltage of the signal line SIG increases.

Next, at time t14, the voltage of the signal line SIG reaches the gradation voltage VG0, and the signal line drive section 4 supplies the signal ramp voltage. In a case where the pixel 8 displays white, the switch 42 maintains the closed state during the supply of the signal ramp voltage.

Next, at time t15, the voltage of the signal line SIG becomes the gradation voltage VG255. Thereafter, the next operation of 1H is performed.

Next, a case where the pixel 8 according to the first embodiment displays black will be described.

First, before time t11, the voltage of the signal line SIG is the gradation voltage VG0.

Next, at time t11, the signal line drive section 4 performs offset precharge. Therefore, the voltage of the signal line SIG decreases. Note that, in the first embodiment, as compared with the first comparative example, the offset precharge direction is reversed similarly to the offset ramp voltage.

In a period from time t12 to time t14, the voltage of the signal line SIG changes substantially similarly to the voltage of the signal line SIG in a case where the pixel 8 displays white.

In a period from time t14 to time t15, the voltage of the signal line SIG remains at the gradation voltage VG0. This is because, in a case where the pixel 8 displays black, the switch 42 illustrated in FIG. 3 is turned off at time t14.

In the first embodiment illustrated in FIG. 5, in a case where the pixel 8 displays white, the anode voltage fluctuates to the positive side from time t12 to around time t14, and thereafter, fluctuates to the negative side due to the signal ramp voltage. On the other hand, in a case where the pixel 8 displays black, the anode voltage fluctuates to the negative side near time t12 due to offset precharge, and fluctuates to the positive side due to the offset ramp signal. In most of the period from time t14 to time t15, the fluctuation of the anode voltage is almost 0.

In the first embodiment illustrated in FIG. 5, as compared with the first comparative example, the period of fluctuation on the positive side of the anode voltage in a case where the pixel 8 displays white is longer, and the period of fluctuation on the negative side is shorter. As a result, the average value of the anode voltage is closer to the positive side as compared with the first comparative example. Therefore, the difference in the average value (luminance) of the anode voltage between white and black is small.

As illustrated in the first embodiment of FIG. 6, the white color in the region corresponding to the signal line SIG1 is substantially the same as the white color in the region corresponding to the signal line SIG2. Therefore, in the first embodiment, the luminance difference (vertical crosstalk) is suppressed. This is because, as illustrated in FIG. 5, the luminance difference between white and black becomes small.

As described above, according to the first embodiment, the signal line drive section 4 supplies the reference voltage to the plurality of signal lines SIG so as to offset the change in the voltage of the anode of the OLED 12 due to the change in the voltage of the signal line SIG. Therefore, deterioration in display quality such as vertical crosstalk can be suppressed.

Note that the display of the display device 1 is not limited to the examples illustrated in FIGS. 3 and 6. For example, even in a case where the display of all the pixels 8 is white, deterioration in display quality can be similarly suppressed by the signal line drive section 4 according to the first embodiment. That is, more appropriate white color can be displayed.

### Modification Example of First Embodiment

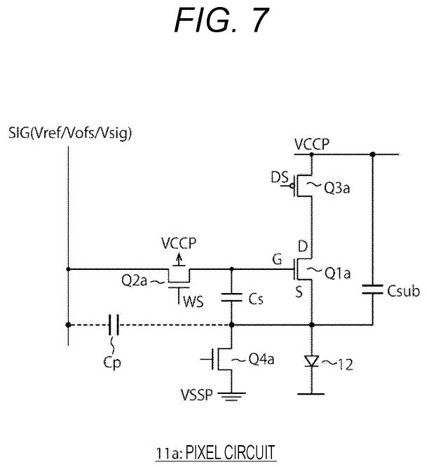

FIG. 7 is a circuit diagram illustrating an example of an internal configuration of a pixel circuit 11a according to a modification example of the first embodiment. The modification example of the first embodiment is different from the first embodiment in a conductivity type of the transistors in the pixel circuit. Hereinafter, differences will be mainly described.

The pixel circuit 11 in FIG. 2 includes the four transistors Q1 to Q4 including P-type MOS transistors, but may include N-type MOS transistors. FIG. 7 is a circuit diagram of the pixel circuit 11a according to the modification example in which the transistors Q1 to Q4 in the pixel circuit 11 of FIG. 2 are configured by N-type MOS transistors Q1a, Q2a, Q3a, and Q4a. The pixel circuit 11a of FIG. 7 performs a similar operation to the pixel circuit 11 of FIG. 2 although the conductivity type is different.

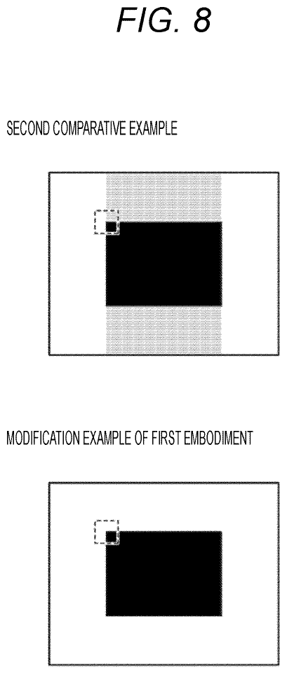

FIG. 8 is a diagram illustrating an example of display of each of the display devices 1 according to the modification example of the first embodiment and a second comparative example. Note that the left side of FIG. 8 illustrates an example of the display of the display device 1 according to the second comparative example. The right side of FIG. 8 illustrates an example of display of the display device 1 according to the modification example of the first embodiment.

The second comparative example is an example of a case where the conductivity type of the transistor in the pixel circuit is different in the first comparative example. Note that, in the modification example of the first embodiment and the second modification example, the relationship of the voltage of the signal line SIG illustrated in FIG. 5 is reversed between black and white.

As illustrated in the second comparative example of FIG. 8, white in the region corresponding to the signal line SIG1 is brighter than white in the region corresponding to the signal line SIG2. Therefore, the second comparative example is different from the first comparative example in the light-dark relationship.

In the modification example of the first embodiment in FIG. 8, similarly to the first embodiment, the white color in the region corresponding to the signal line SIG1 is substantially the same as the white color in the region corresponding to the signal line SIG2.

As in the modification example of the first embodiment, the conductivity types of the transistors may be different. Also in this case, the similar effects to those of the first embodiment can be obtained.

### Second Embodiment

FIG. 9 is a timing chart illustrating an example of operation of a pixel 8 according to a second embodiment. The second embodiment is different from the first embodiment in the voltage of the signal line SIG. Hereinafter, differences will be mainly described.

The signal line drive section 4 supplies an offset precharge voltage at which the voltage level of the signal line SIG becomes a first level (in the example illustrated in FIG. 9, gradation voltage VG0), supplies an offset ramp voltage after supplying the offset precharge voltage, and generates a signal ramp voltage after supplying the offset ramp voltage.

The offset ramp voltage changes from a high side to a low side. That is, the offset ramp voltage and the signal ramp voltage change with time in the same direction.

The signal line drive section 4 extends a period (sum of periods T1, T2) from the start of generation of the offset precharge voltage (time t21) to the start of generation of the offset ramp voltage.

More specifically, during a period from when the voltage of the signal line SIG becomes the first level to when the offset ramp voltage is supplied, the signal line drive section 4 maintains the voltage of the signal line SIG at the first level for a second predetermined period (period T2). More specifically, the ramp wave generation circuit 41 delays the start of generation of the offset ramp voltage. That is, after the offset precharge voltage is generated, the ramp wave generation circuit 41 generates the offset ramp voltage after the period T2 elapses.

A period T1 is a period in which the voltage of the signal line SIG reaches the gradation voltage VG0 from the gradation voltage VG255. The period T2 is a period in which the voltage of the signal line SIG is maintained at the gradation voltage VG0.

In the example illustrated in FIG. 9, by providing the period T2, the period during which the anode voltage fluctuates to the positive side can be extended. As a result, deterioration in display quality such as vertical crosstalk can be suppressed.

Note that the operation of the pixel 8 after time t23 is substantially the same as the operation after time t2 illustrated in the first comparative example of FIG. 5.

As in the second embodiment, the voltage of the signal line SIG may be changed. Also in this case, the similar effects to those of the first embodiment can be obtained.

### Modification Example of Second Embodiment

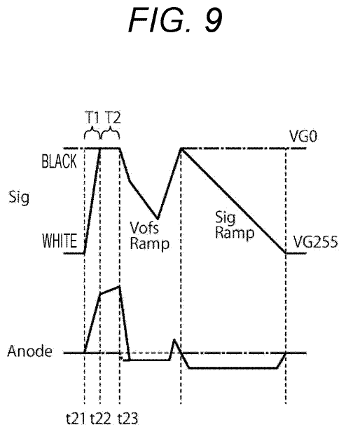

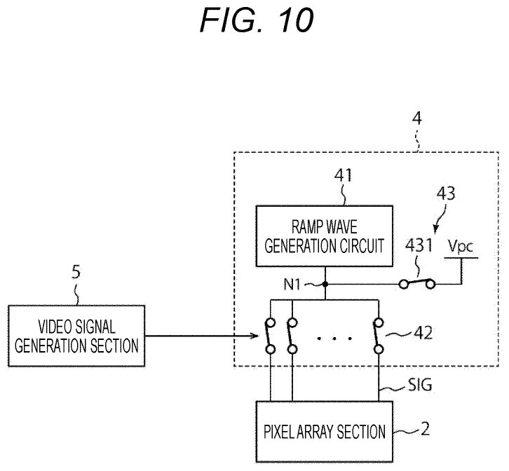

FIG. 10 is a circuit diagram illustrating an example of a configuration of a signal line drive section 4 according to a modification example of the second embodiment. The modification example of the second embodiment is different from the second embodiment in the configuration of the signal line drive section 4. Hereinafter, differences will be mainly described.

In the modification example of the second embodiment, a change in the voltage of the signal line SIG illustrated in FIG. 9 is obtained by changing the configuration of the signal line drive section 4.

The signal line drive section 4 further includes a voltage maintenance section 43. The voltage maintenance section 43 maintains the voltage of the signal line SIG at the first level for a second predetermined period (period T2) from when the voltage of the signal line SIG becomes the first level to when the offset ramp voltage is supplied.

The voltage maintenance section 43 includes a reference voltage node Vpc and a switch 431.

The reference voltage node Vpc is a power source for precharging.

The switch 431 is provided between the reference voltage node Vpc and a node N1. The node N1 is a node between the ramp wave generation circuit 41 and the switch 42. The switch 431 is turned on at offset precharge timing (time t21) and turned off at time t23. Therefore, the voltage of the signal line SIG illustrated in FIG. 9 can be obtained.

As in the modification example of the second embodiment, the configuration of the signal line drive section 4 may be changed. Also in this case, the similar effects to those of the second embodiment can be obtained.

### Third Embodiment

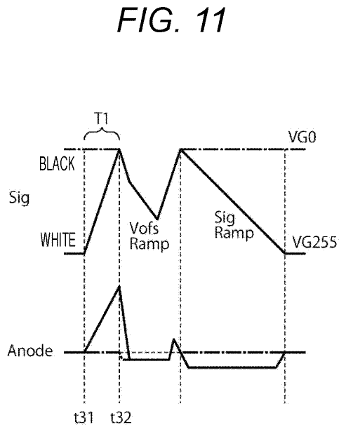

FIG. 11 is a timing chart illustrating an example of operation of a pixel 8 according to a third embodiment. The third embodiment is different from the first embodiment in the voltage of the signal line SIG. Hereinafter, differences will be mainly described.

The signal line drive section 4 slows the change (rise) of the offset precharge voltage. More specifically, the ramp wave generation circuit 41 generates an offset precharge voltage that changes (rises) slower than a predetermined speed.

In the example illustrated in FIG. 11, by extending the period T1, the period during which the anode voltage fluctuates to the positive side can be extended. As a result, deterioration in display quality such as vertical crosstalk can be suppressed.

Note that the operation of the pixel 8 after time t32 is substantially the same as the operation after time t2 illustrated in the first comparative example of FIG. 5.

As in the third embodiment, the voltage of the signal line SIG may be changed. Also in this case, the similar effects to those of the first embodiment can be obtained.

### First Modification Example of Third Embodiment

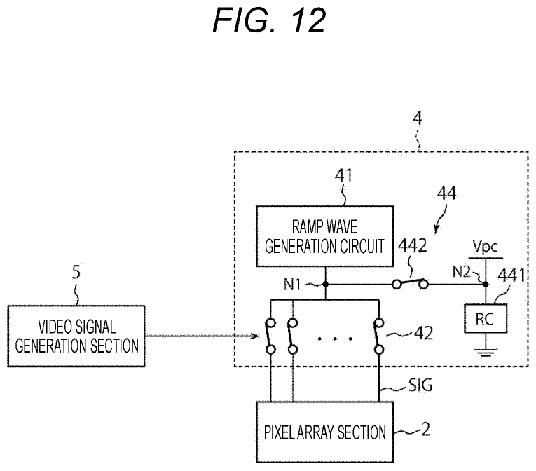

FIG. 12 is a circuit diagram illustrating an example of a configuration of a signal line drive section 4 according to a first modification example of the third embodiment. The first modification example of the third embodiment is different from the third embodiment in the configuration of the signal line drive section 4. Hereinafter, differences will be mainly described.

In the first modification example of the third embodiment, a change in the voltage of the signal line SIG illustrated in FIG. 11 is obtained by changing the configuration of the signal line drive section 4.

The signal line drive section 4 further includes a delay section 44. The delay section 44 slows the change (rise) of the offset precharge voltage.

The delay section 44 further includes a reference voltage node Vpc, an RC circuit 441, and a switch 442.

The reference voltage node Vpc is electrically connected to a node N2.

The RC circuit 441 is connected between the node N2 and the ground. The RC circuit 441 delays the rise of the voltage.

The switch 442 is connected between the node N1 and the node N2. The switch 442 is turned on at offset precharge timing (time t21) and turned off at time t23. Therefore, the voltage of the signal line SIG illustrated in FIG. 11 can be obtained.

As in the First Modification Example of the Third

embodiment, the configuration of the signal line drive section 4 may be changed. Also in this case, effects similar to those of the third embodiment can be obtained.

### Second Modification Example of Third Embodiment

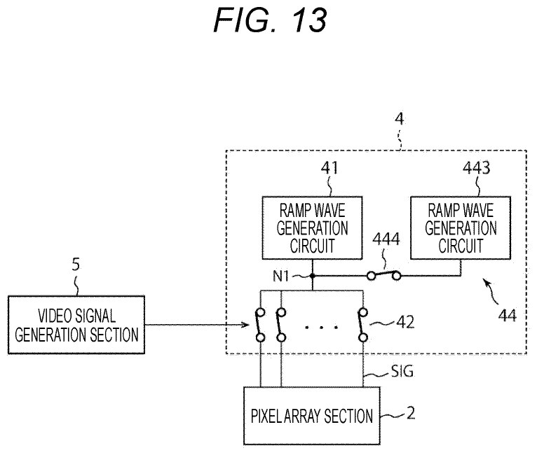

FIG. 13 is a circuit diagram illustrating an example of a configuration of a signal line drive section 4 according to a second modification example of the third embodiment. The second modification example of the third embodiment is different from the third embodiment in the configuration of the signal line drive section 4. Hereinafter, differences will be mainly described.

A delay section 44 further includes a ramp wave generation circuit 443 and a switch 444.

The ramp wave generation circuit 443 is a circuit different from the ramp wave generation circuit 41. The ramp wave generation circuit 443 generates an offset precharge voltage.

The switch 444 is connected between the node N1 and the ramp wave generation circuit 443. The switch 444 is turned on at offset precharge timing (time t21) and turned off at time t23. Therefore, the voltage of the signal line SIG illustrated in FIG. 11 can be obtained.

As in the second modification example of the third embodiment, the configuration of the signal line drive section 4 may be changed. Also in this case, effects similar to those of the third embodiment can be obtained.

### Third Modification Example of Third Embodiment

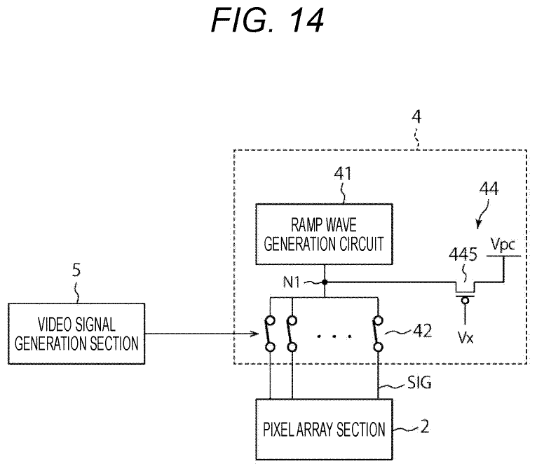

FIG. 14 is a circuit diagram illustrating an example of a configuration of a signal line drive section 4 according to a third modification example of the third embodiment. The third modification example of the third embodiment is different from the third embodiment in the configuration of the signal line drive section 4. Hereinafter, differences will be mainly described.

A delay section 44 includes a reference voltage node Vpc and a transistor 445.

The transistor 445 is connected between the node N1 and the reference voltage node Vpc. A signal Vx is input to the gates of the transistor 445. The transistor 445 is, for example, a P-type MOS transistor.

The transistor 445 is turned on at offset precharge timing (time t21) and turned off at time t23. Therefore, the voltage of the signal line SIG illustrated in FIG. 11 can be obtained.

As in the third modification example of the third embodiment, the configuration of the signal line drive section 4 may be changed. Also in this case, effects similar to those of the third embodiment can be obtained.

### Fourth Embodiment

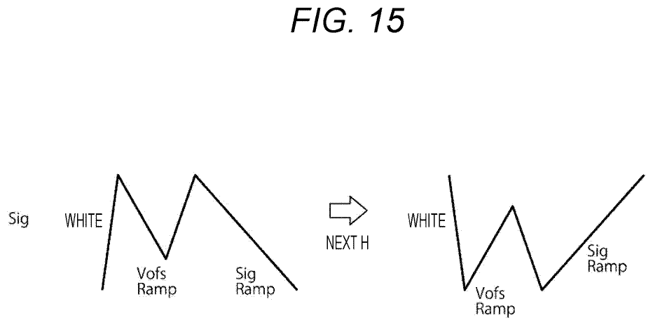

FIG. 15 is a timing chart illustrating an example of operation of a pixel 8 according to a fourth embodiment. The fourth embodiment is different from the first embodiment in the voltage of the signal line SIG. Hereinafter, differences will be mainly described.

The ramp wave generation voltage generates an offset ramp voltage whose voltage level changes with time, and generates a signal ramp voltage after generating the offset ramp voltage. Furthermore, in the example illustrated in FIG. 15, the offset ramp voltage and the signal ramp voltage change with time in the same direction.

The ramp wave generation circuit 41 generates a reference voltage that changes in a reverse direction every third predetermined period. The third predetermined period is, for example, one horizontal period (1H). This makes it possible to offset the fluctuation of the anode voltage. As a result, deterioration in display quality such as vertical crosstalk can be suppressed.

As in the fourth embodiment, the voltage of the signal line SIG may be changed. Also in this case, the similar effects to those of the first embodiment can be obtained.

### Fifth Embodiment

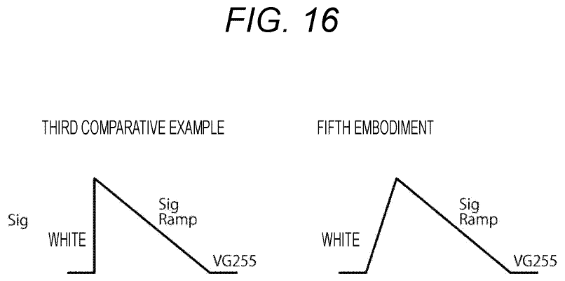

FIG. 16 is a timing chart illustrating an example of operation of a pixel 8 according to a fifth embodiment. The fourth embodiment is different from the first embodiment in the voltage of the signal line SIG. Hereinafter, differences will be mainly described.

The ramp wave generation circuit 41 does not generate an offset ramp voltage.

The signal line drive section 4 slows the change (rise) of the voltage of the signal line SIG up to the second level which is the voltage level at the start of supplying the signal ramp voltage. Therefore, the period during which the anode voltage fluctuates to the positive side can be extended as compared with the third comparative example in which the voltage rises quickly. As a result, deterioration in display quality such as vertical crosstalk can be suppressed. The second level is, for example, the gradation voltage VG0.

Note that the ramp wave generation circuit 41 may generate a voltage having a slow rise, and the signal line drive section 4 may have a configuration (See, for example, the first to third modification examples of the third embodiment.) that delays the rise.

As in the fifth embodiment, the voltage of the signal line SIG may be changed. Also in this case, the similar effects to those of the first embodiment can be obtained.

### Sixth Embodiment

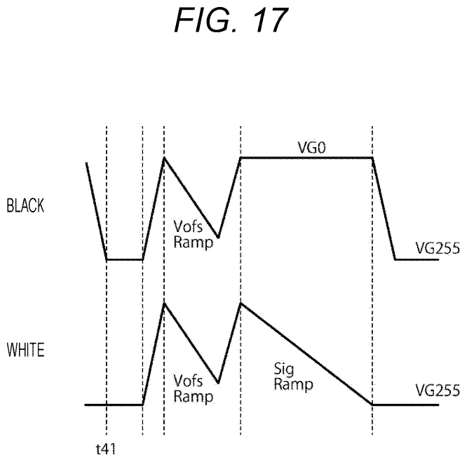

FIG. 17 is a timing chart illustrating an example of operation of a pixel 8 according to a sixth embodiment. The fifth embodiment is different from the first embodiment in the voltage of the signal line SIG. Hereinafter, differences will be mainly described.

A ramp wave generation circuit 41 generates an offset voltage whose voltage level changes with time, and generates a signal ramp voltage after generating the offset voltage. Furthermore, in the example illustrated in FIG. 17, the offset ramp voltage and the signal ramp voltage change with time in the same direction.

Before generating the offset voltage (time t41), the ramp wave generation circuit 41 generates a voltage that brings the voltage level of the signal line SIG to a third level, which is substantially the same voltage level as the voltage at the end of the change in the signal ramp voltage. In the example illustrated in FIG. 17, the third level is the gradation voltage VG255. Therefore, in a case where the pixel 8 displays black, the anode voltage fluctuates to the negative side. As a result, as compared with the first comparative example illustrated in FIG. 5, the average value of the anode voltage in the case of displaying black can be reduced, and the luminance difference can be suppressed. As a result, deterioration in display quality such as vertical crosstalk can be suppressed.

Note that, in FIG. 17, the ramp wave generation circuit 41 may not generate the offset ramp voltage. In this case, the ramp wave generation circuit 41 generates a voltage that brings the voltage level of the signal line SIG to the third level before generating the signal ramp voltage.

As in the sixth embodiment, the voltage of the signal line SIG may be changed. Also in this case, the similar effects to those of the first embodiment can be obtained.

### Configuration Example of Pixel

Hereinafter, another configuration example of the subpixel 8a will be described. Note that hereinafter, the subpixel 8a is referred to as a pixel PIX.

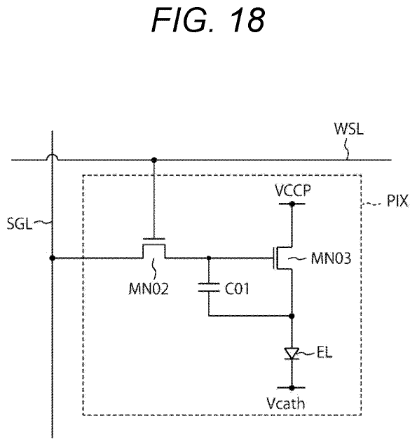

FIG. 18 represents a configuration example of the pixel PIX. The pixel PIX includes a capacitor C01, transistors MN02 and MN03, and a light emitting element EL. The transistors MN02 and MN03 are N-type metal oxide semiconductor field effect transistors (MOSFETs). The gate of the transistor MN02 is connected to a control line WSL, the drain is connected to a signal line SGL, and the source is connected to the gate of the transistor MN03 and the capacitor C01. One end of the capacitor C01 is connected to the source of the transistor MN02 and the gate of the transistor MN03, and the other end is connected to the source of the transistor MN03 and the anode of the light emitting element EL. The gate of the transistor MN03 is connected to the source of the transistor MN02 and one end of the capacitor C01, the drain is connected to a power supply line VCCP, and the source is connected to the other end of the capacitor C01 and the anode of the light emitting element EL. The light emitting element EL is, for example, an organic EL light emitting element, the anode is connected to the source of the transistor MN03 and the other end of the capacitor C01, and the cathode is connected to a power supply line Vcath.

With this configuration, in the pixel PIX, when the transistor MN02 is in the on state, the voltage between both ends of the capacitor C01 is set on the basis of the pixel signal supplied from the signal line SGL. The transistor MN03 causes a current according to the voltage between both ends of the capacitor C01 to flow through the light emitting element EL. The light emitting element EL emits light on the basis of the current supplied from the transistor MN03. In this manner, the pixel PIX emits light with luminance according to the pixel signal.

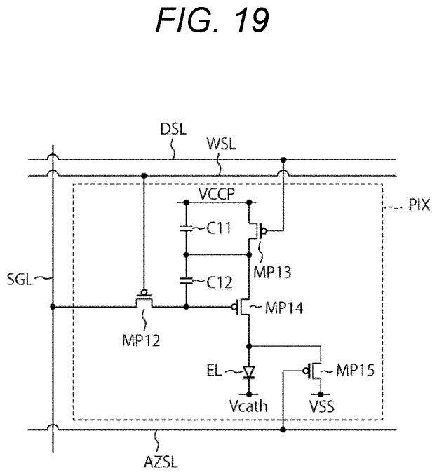

FIG. 19 represents another configuration example of the pixel PIX. The pixel PIX includes capacitors C11 and C12, transistors MP12 to MP15, and a light emitting element EL. The transistors MP12 to MP15 are P-type MOSFETs. The gate of the transistor MP12 is connected to the control line WSL, the source is connected to the signal line SGL, and the drain is connected to the gate of the transistor MP14 and the capacitor C12. One end of the capacitor C11 is connected to the power supply line VCCP, and the other end is connected to the capacitor C12, the drain of the transistor MP13, and the source of the transistor MP14. One end of the capacitor C12 is connected to the other end of the capacitor C11, the drain of the transistor MP13, and the source of the transistor MP14, and the other end is connected to the drain of the transistor MP12 and the gate of the transistor MP14. The gate of the transistor MP13 is connected to the control line DSL, the source is connected to the power supply line VCCP, and the drain is connected to the source of the transistor MP14, the other end of the capacitor C11, and one end of the capacitor C12. The gate of the transistor MP14 is connected to the drain of the transistor MP12 and the other end of the capacitor C12, the source is connected to the drain of the transistor MP13, the other end of the capacitor C11, and one end of the capacitor C12, and the drain is connected to the anode of the light emitting element EL and the source of the transistor MP15. The gate of the transistor MP15 is connected to the control line AZSL, the source is connected to the drain of the transistor MP14 and the anode of the light emitting element EL, and the drain is connected to the power supply line VSS.

With this configuration, in the pixel PIX, the transistor MP12 is in the on state, so that the voltage between both ends of the capacitor C12 is set on the basis of the pixel signal supplied from the signal line SGL. The transistor MP13 is turned on and off on the basis of the signal of the control line DSL. The transistor MP14 causes a current according to the voltage between both ends of the capacitor C12 to flow through the light emitting element EL during the period in which the transistor MP13 is in the on state. The light emitting element EL emits light on the basis of the current supplied from the transistor MP14. In this manner, the pixel PIX emits light with luminance according to the pixel signal. The transistor MP15 is turned on and off on the basis of the signal of the control line AZSL. During the period in which the transistor MP15 is in the on state, the voltage of the anode of the light emitting element EL is initialized by being set to the voltage of the power supply line VSS.

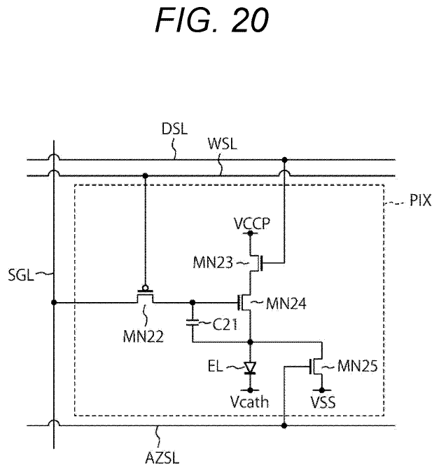

FIG. 20 represents another configuration example of the pixel PIX. The pixel PIX includes a capacitor C21, transistors MN22 to MN25, and a light emitting element EL. The transistors MN22 to MN25 are N-type MOSFETs. The gate of the transistor MN22 is connected to the control line WSL, the drain is connected to the signal line SGL, and the source is connected to the gate of the transistor MN24 and the capacitor C21. One end of the capacitor C21 is connected to the source of the transistor MN22 and the gate of the transistor MN24, and the other end is connected to the source of the transistor MN24, the drain of the transistor MN25, and the anode of the light emitting element EL. The gate of the transistor MN23 is connected to the control line DSL, the drain is connected to the power supply line VCCP, and the source is connected to the drain of the transistor MN24. The gate of the transistor MN24 is connected to the source of the transistor MN22 and one end of the capacitor C21, the drain is connected to the source of the transistor MN23, and the source is connected to the other end of the capacitor C21, the drain of the transistor MN25, and the anode of the light emitting element EL. The gate of the transistor MN25 is connected to the control line AZSL, the drain is connected to the source of the transistor MN24, the other end of the capacitor C21, and the anode of the light emitting element EL, and the source is connected to the power supply line VSS.

With this configuration, in the pixel PIX, when the transistor MN22 is in the on state, the voltage between both ends of the capacitor C21 is set on the basis of the pixel signal supplied from the signal line SGL. The transistor MN23 is turned on and off on the basis of the signal of the control line DSL. The transistor MN24 causes a current according to the voltage between both ends of the capacitor C21 to flow to the light emitting element EL during the period in which the transistor MN23 is in the on state. The light emitting element EL emits light on the basis of the current supplied from the transistor MN24. In this manner, the pixel PIX emits light with luminance according to the pixel signal. The transistor MN25 is turned on and off on the basis of the signal of the control line AZSL. During the period in which the transistor MN25 is in the on state, the voltage of the anode of the light emitting element EL is initialized by being set to the voltage of the power supply line VSS.

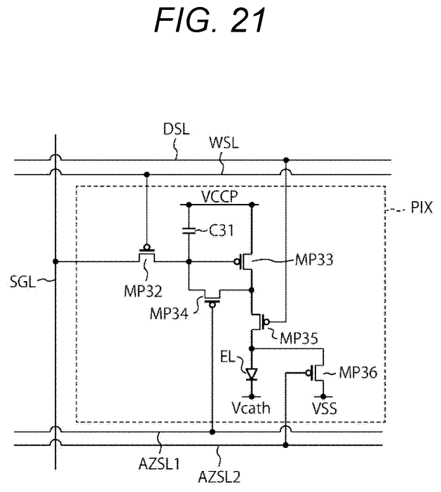

FIG. 21 represents another configuration example of the pixel PIX. The pixel PIX includes a capacitor C31, transistors MP32 to MP36, and a light emitting element EL. The transistors MP32 to MP36 are P-type MOSFETs. The gate of the transistor MP32 is connected to the control line WSL, the source is connected to the signal line SGL, and the drain is connected to the gate of the transistor MP33, the drain of the transistor MP34, and the capacitor C31. One end of the capacitor C31 is connected to the power supply line VCCP, and the other end is connected to the drain of the transistor MP32, the gate of the transistor MP33, and the drain of the transistor MP34. The gate of the transistor MP34 is connected to the control line AZSL1, the source is connected to the drain of the transistor MP33 and the source of the transistor MP35, and the drain is connected to the drain of the transistor MP32, the gate of the transistor MP33, and the other end of the capacitor C31. The gate of the transistor MP35 is connected to the control line DSL, the source is connected to the drain of the transistor MP33 and the source of the transistor MP34, and the drain is connected to the source of the transistor MP36 and the anode of the light emitting element EL. The gate of the transistor MP36 is connected to the control line AZSL2, the source is connected to the drain of the transistor MP35 and the anode of the light emitting element EL, and the drain is connected to the power supply line VSS.

With this configuration, in the pixel PIX, the transistor MP32 is in the on state, so that the voltage between both ends of the capacitor C31 is set on the basis of the pixel signal supplied from the signal line SGL. The transistor MP35 is turned on and off on the basis of the signal of the control line DSL. The transistor MP33 causes a current according to the voltage between both ends of the capacitor C31 to flow to the light emitting element EL during the period in which the transistor MP35 is in the on state. The light emitting element EL emits light on the basis of the current supplied from the transistor MP33. In this manner, the pixel PIX emits light with luminance according to the pixel signal. The transistor MP34 is turned on and off on the basis of the signal of the control line AZSL1. The drain and the gate of the transistor MP34 are connected to each other during the period in which the transistor MP33 is in the on state. The transistor MP36 is turned on and off on the basis of the signal of the control line AZSL2. During the period in which the transistor MP36 is in an on state, the voltage of the anode of the light emitting element EL is initialized by being set to the voltage of the power supply line VSS.

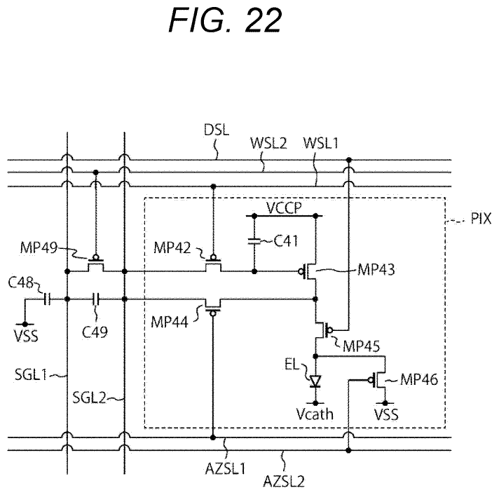

FIG. 22 represents another configuration example of the pixel PIX. One end of a capacitor C48 is connected to the signal line SGL1, and the other end is connected to the power supply line VSS. One end of a capacitor C49 is connected to the signal line SGL1, and the other end is connected to the signal line SGL2. A transistor MP49 is a P-type MOSFET, and has a gate connected to the control line WSL2, a source connected to the signal line SGL1, and a drain connected to the signal line SGL2.

The pixel PIX includes a capacitor C41, transistors MP42 to MP46, and a light emitting element EL. The transistors MP42 to MP46 are P-type MOSFETs. The gate of the transistor MP42 is connected to the control line WSL1, the source is connected to the signal line SGL2, and the drain is connected to the gate of the transistor MP43 and the capacitor C41. One end of the capacitor C41 is connected to the power supply line VCCP, and the other end is connected to the drain of the transistor MP42 and the gate of the transistor MP43. The gate of the transistor MP43 is connected to the drain of the transistor MP42 and the other end of the capacitor C41, the source is connected to the power supply line VCCP, and the drain is connected to the sources of the transistors MP44 and MP45. The gate of the transistor MP44 is connected to the control line AZSL1, the source is connected to the drain of the transistor MP43 and the source of the transistor MP45, and the drain is connected to the signal line SGL2. The gate of the transistor MP45 is connected to the control line DSL, the source is connected to the drain of the transistor MP43 and the source of the transistor MP44, and the drain is connected to the source of the transistor MP46 and the anode of the light emitting element EL. The gate of the transistor MP46 is connected to the control line AZSL2, the source is connected to the drain of the transistor MP45 and the anode of the light emitting element EL, and the drain is connected to the power supply line VSS.

With this configuration, in the pixel PIX, when the transistor MP42 is in the on state, the voltage between both ends of the capacitor C49 is set on the basis of the pixel signal supplied from the signal line SGL1 via the capacitor C41. The transistor MP45 is turned on and off on the basis of the signal of the control line DSL. The transistor MP43 causes a current according to the voltage between both ends of the capacitor C41 to flow through the light emitting element EL during the period in which the transistor MP45 is in the on state. The light emitting element EL emits light on the basis of the current supplied from the transistor MP43. In this manner, the pixel PIX emits light with luminance according to the pixel signal. The transistor MP44 is turned on and off on the basis of the signal of the control line AZSL1. During the period in which the transistor MP44 is in the on state, the drain of the transistor MP43 and the signal line SGL2 are connected to each other. The transistor MP46 is turned on and off on the basis of the signal of the control line AZSL2. During the period in which the transistor MP46 is in the on state, the voltage of the anode of the light emitting element EL is initialized by being set to the voltage of the power supply line VSS.

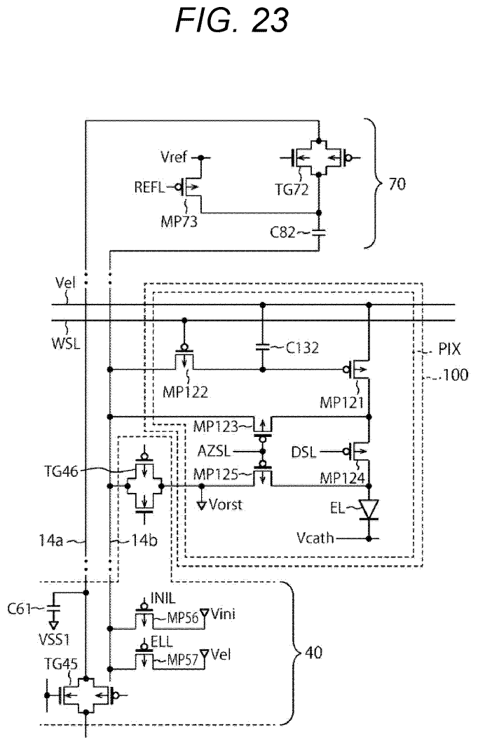

FIG. 23 represents another configuration example of the pixel PIX. A plurality of the pixels PIX is provided in a matrix in a display area 100, and the display area 100 is provided between a first control section 40 and a second control section 70.

The first control section 40 includes transmission gates TG45 and TG46, transistors MP56 and MP57, and a capacitor C61. The transistors MP56 and MP57 are P-type MOSFETs. A pixel signal is supplied to an input end of the transmission gate TG45, and an output end of the transmission gate TG45 is connected to one end of a signal line 14a. An input end of the transmission gate TG46 is connected to a signal line 14b, and an output end of the transmission gate TG46 is connected to the power supply line Vorst. One end of the capacitor C61 is connected to the signal line 14a, and the other end is connected to the power supply line VSS1. The gate of the transistor MP56 is connected to the control line INIL, the source is connected to the power supply line Vini, and the drain is connected to the signal line 14b. The gate of the transistor MP57 is connected to the control line ELL, the source is connected to the power supply line Vel, and the drain is connected to the signal line 14b.

The second control section 70 includes a transmission gate TG72, a transistor MP73, and a capacitor C82. The transistor MP73 is a P-type MOSFET. The input end of the transmission gate TG72 is connected to the other end of the signal line 14a, and the output end is connected to the drain of the transistor MP73 and one end of the capacitor C82. The gate of the transistor MP73 is connected to the control line REFL, the source is connected to the power supply line Vref, and the drain is connected to an output end of the transmission gate TG72 and one end of the capacitor C82. One end of the capacitor C82 is connected to the output end of the transmission gate TG72 and the drain of the transistor MP73, and the other end is connected to one end of the signal line 14b.

The pixel PIX includes a capacitor C132, transistors MP121 to MP125, and a light emitting element EL. The transistors MP121 to MP125 are P-type MOSFETs. The gate of the transistor MP122 is connected to the control line WSL, the source is connected to the signal line 14b, and the drain is connected to the gate of the transistor MP121 and the capacitor C132. One end of the capacitor C132 is connected to the power supply line Vel, and the other end is connected to the drain of the transistor MP122 and the gate of the transistor MP121. The gate of the transistor MP121 is connected to the drain of the transistor MP122 and the other end of the capacitor C132, the source is connected to the power supply line Vel, and the drain is connected to the sources of the transistors MP123 and MP124. The gate of the transistor MP123 is connected to the control line AZSL, the source is connected to the drain of the transistor MP121 and the source of the transistor MP124, and the drain is connected to the signal line 14b. The gate of the transistor MP124 is connected to the control line DSL, the source is connected to the drain of the transistor MP121 and the source of the transistor MP123, and the drain is connected to the drain of the transistor MP125 and the anode of the light emitting element 130. The gate of the transistor MP125 is connected to the control line AZSL, the source is connected to the power supply line Vorst, and the drain is connected to the drain of the transistor MP124 and the anode of the light emitting element 130.

With this configuration, in the pixel PIX, when the transistor MP122 is in an on state, the voltage between both ends of the capacitor C132 is set on the basis of the pixel signal supplied via the transmission gate TG45, the signal line 14a, the transmission gate TG72, the capacitor C82, and the signal line 14b. The transistor MP124 is turned on and off on the basis of the signal of the control line DSL. The transistor MP121 causes a current according to the voltage between both ends of the capacitor C132 to flow through the light emitting element EL during the period in which the transistor MP124 is in an on state. The light emitting element EL emits light on the basis of the current supplied from the transistor MP121. In this manner, the pixel PIX emits light with luminance according to the pixel signal. The transistors MP123 and MP125 are turned on and off on the basis of the signal of the control line AZSL. During a period in which the transistor MP123 is in an on state, the drain of the transistor MP121 and the source of the transistor MP124 are connected to the signal line 14b. During the period in which the transistor MP125 is in an on state, the voltage of the anode of the light emitting element EL is initialized by being set to the voltage of the power supply line Vorst. Furthermore, the transistor MP56 is turned on/off on the basis of the signal of the control line INIL, the transistor MP57 is turned on/off on the basis of the signal of the control line ELL, and the transistor MP73 is turned on/off on the basis of the signal of the control line REFL. When the transistor MP56 is in an on state, the signal line 14b is set to the voltage of the power supply line Vini, and when the transistor MP57 is in an on state, the signal line 14b is set to the voltage of the power supply line Vel. When the transistor MP73 is in an on state, one end of the capacitor C82 is initialized by being set to the voltage of the power supply line Vref.

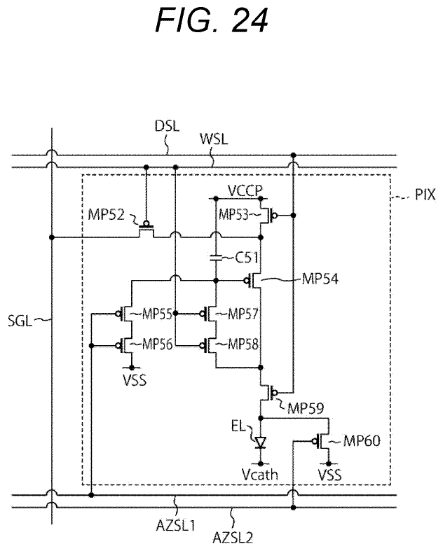

FIG. 24 represents another configuration example of the pixel PIX. The pixel PIX includes a capacitor C51, transistors MP52 to MP60, and a light emitting element EL. The transistors MP52 to MP60 are P-type MOSFETs. The gate of the transistor MP52 is connected to the control line WSL, the source is connected to the signal line SGL, and the drain is connected to the drain of the transistor MP53 and the source of the transistor MP54. The gate of the transistor MP53 is connected to the control line DSL, the source is connected to the power supply line VCCP, and the drain is connected to the drain of the transistor MP52 and the source of the transistor MP54. The gate of the transistor MP54 is connected to the source of the transistor MP55, the drain of the transistor MP57, and the capacitor C51, the source is connected to the drains of the transistors MP52 and MP53, and the drain is connected to the sources of the transistors MP58 and MP59. One end of the capacitor C51 is connected to the power supply line VCCP, and the other end is connected to the gate of the transistor MP54, the source of the transistor MP55, and the drain of the transistor MP57. The capacitor C51 may include two capacitors connected in parallel to each other. The gate of the transistor MP55 is connected to the control line AZSL1, the source is connected to the gate of the transistor MP54, the drain of the transistor MP57, and the other end of the capacitor C51, and the drain is connected to the source of the transistor MP56. The gate of the transistor MP56 is connected to the control line AZSL1, the source is connected to the drain of the transistor MP55, and the drain is connected to the power supply line VSS. The gate of the transistor MP57 is connected to the control line WSL, the drain is connected to the gate of the transistor MP54, the source of the transistor MP55, and the other end of the capacitor C51, and the source is connected to the drain of the transistor MP58. The gate of the transistor MP58 is connected to the control line WSL, the drain is connected to the source of the transistor MP57, and the source is connected to the drain of the transistor MP54 and the source of the transistor MP59. The gate of the transistor 59 is connected to the control line DSL, the source is connected to the drain of the transistor MP54 and the source of the transistor MP58, and the drain is connected to the source of the transistor MP60 and the anode of the light emitting element EL. The gate of the transistor MP60 is connected to the control line AZSL2, the source is connected to the drain of the transistor MP59 and the anode of the light emitting element EL, and the drain is connected to the power supply line VSS.

With this configuration, in the pixel PIX, the transistors MP52, MP54, MP58, and MP57 are in the on state, whereby the voltage between both ends of the capacitor C51 is set on the basis of the pixel signal supplied from the signal line SGL. The transistors MP53 and MP59 are turned on and off on the basis of the signal of the control line DSL. The transistor MP54 causes a current according to the voltage between both ends of the capacitor C51 to flow through the light emitting element EL during the period in which the transistors MP53 and MP59 are in the on state. The light emitting element EL emits light on the basis of the current supplied from the transistor MP54. In this manner, the pixel PIX emits light with luminance according to the pixel signal. The transistors MP55 and MP56 are turned on and off on the basis of the signal of the control line AZSL1. During the period in which the transistors MP55 and MP56 are in the on state, the voltage of the gate of the transistor MP54 is initialized by being set to the voltage of the power supply line VSS. The transistor MP60 is turned on and off on the basis of the signal of the control line AZSL2. During the period in which the transistor MP60 is in the on state, the voltage of the anode of the light emitting element EL is initialized by being set to the voltage of the power supply line VSS.

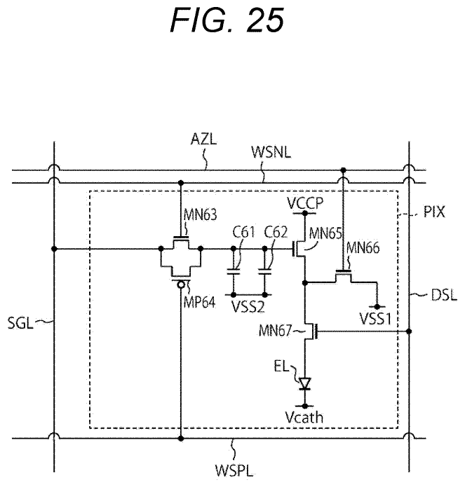

FIG. 25 represents another configuration example of the pixel PIX. The signal of the control line WSNL and the signal of the control line WSPL are inverted signals.

The pixel PIX includes capacitors C61 and C62, transistors MN63, MP64, and MN65 to MN67, and a light emitting element EL. The transistors MN63 and MN65 to MN67 are N-type MOSFETs, and the transistor MP64 is a P-type MOSFET. The gate of the transistor MN63 is connected to the control line WSNL, the drain is connected to the signal line SGL and the source of the transistor MP64, and the source is connected to the drain of the transistor MP64, the capacitors C61 and C62, and the gate of the transistor MN65. The gate of the transistor MP64 is connected to the control line WSPL, the source is connected to the signal line SGL and the drain of the transistor MN63, and the drain is connected to the source of the transistor MN63, the capacitors C61 and C62, and the gate of the transistor MN65. The capacitor C61 includes, for example, a metal oxide metal (MOM) capacitor, one end is connected to the source of the transistor MN63, the drain of the transistor MP64, the capacitor C62, and the gate of the transistor MN65, and the other end is connected to the power supply line VSS2. Note that the capacitor C61 may be configured using, for example, a MOS capacitor or a metal insulator metal (MIM) capacitor. The capacitor C62 includes, for example, a MOS capacitor, one end is connected to the source of the transistor MN63, the drain of the transistor MP64, one end of the capacitor C61, and the gate of the transistor MN65, and the other end is connected to the power supply line VSS2. Note that the capacitor C62 may be configured using, for example, an MOM capacitor or an MIM capacitor. The gate of the transistor MN65 is connected to the source of the transistor MN63, the drain of the transistor MP64, and one end of the capacitors C61 and C62, the drain is connected to the power supply line VCCP, and the source is connected to the drains of the transistors MN66 and MN67. The gate of the transistor MN66 is connected to the control line AZL, the drain is connected to the source of the transistor MN65 and the drain of the transistor MN67, and the source is connected to the power supply line VSS1. The gate of the transistor MN67 is connected to the control line DSL, the drain is connected to the source of the transistor MN65 and the drain of the transistor MN66, and the source is connected to the anode of the light emitting element EL.

With this configuration, in the pixel PIX, at least one of the transistors MN63 or MP64 is in the on state, so that the voltage between both ends of the capacitors C61 and C62 is set on the basis of the pixel signal supplied from the signal line SGL. The transistor MN67 is turned on and off on the basis of the signal of the control line DSL. The transistor MN65 causes a current according to the voltage between both ends of the capacitors C61 and C62 to flow through the light emitting element EL during the period in which the transistor MN67 is in the on state. The light emitting element EL emits light on the basis of the current supplied from the transistor MP65. In this manner, the pixel PIX emits light with luminance according to the pixel signal. The transistor MN66 may be turned on and off on the basis of the signal of the control line AZL. Furthermore, the transistor MN66 may function as a resistance element having a resistance value according to the signal of the control line AZL. In this case, the transistor MN65 and the transistor MN66 constitute a so-called source follower circuit.

### APPLICATION EXAMPLE

Next, Application examples of the display system described in the above embodiments and modification examples will be described.

### Application Example 1

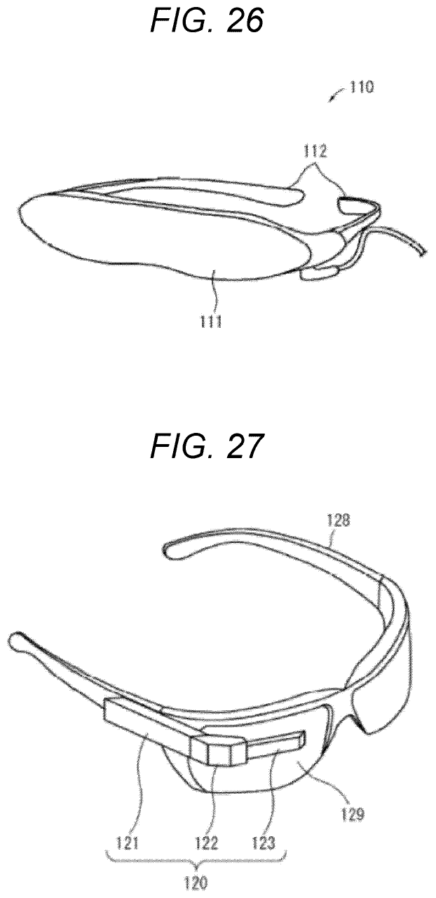

FIG. 26 represents an example of an external appearance of a head mounted display 110. The head mounted display 110 includes, for example, ear hooking portions 112 to be worn on the head of the user on both sides of the glass-shaped display section 111. The technology according to the above embodiments and the like can be applied to such the head mounted display 110.

### Application Example 2

FIG. 27 represents an example of an external appearance of another head mounted display 120. The head mounted display 120 is a transmissive head mounted display including a main body portion 121, an arm portion 122, and a lens barrel portion 123. The head mounted display 120 is mounted on glasses 128. The main body portion 121 includes a control board and a display section for controlling the operation of the head mounted display 120. The display section emits image light of a display image. The arm portion 122 connects the main body portion 121 and the lens barrel portion 123 and supports the lens barrel portion 123. The lens barrel portion 123 projects image light supplied from the main body portion 121 via the arm portion 122 toward the user's eyes via the lens 129 of the glasses 128. The technology according to the above embodiment and the like can be applied to such the head mounted display 120.

Note that the head mounted display 120 is a so-called light guide plate type head mounted display, but is not limited thereto, and may be, for example, a so-called bird bus type head mounted display. The bird bus type head mounted display includes, for example, a beam splitter and a partially transparent mirror. The beam splitter outputs light encoded with the image information toward the mirror, and the mirror reflects the light toward the user's eyes. Both the beam splitter and the partially transparent mirror are partially transparent. Therefore, light from the surrounding environment reaches the eyes of the user.

### Application Example 3

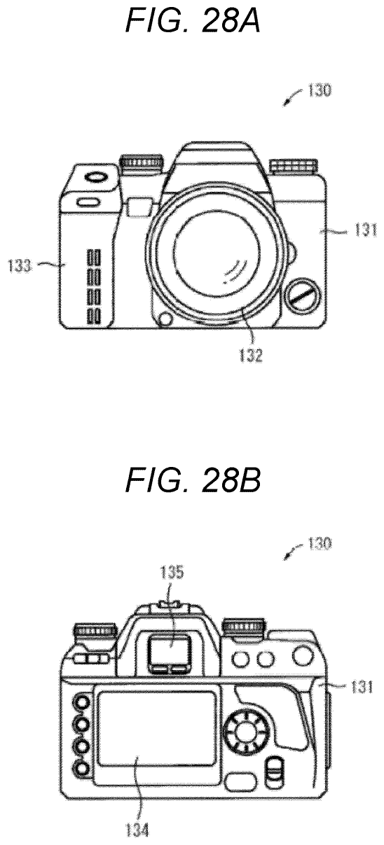

FIGS. 28A and 28B represent an example of an external appearance of a digital still camera 130, FIG. 28A illustrates a front view, and FIG. 28B illustrates a rear view. The digital still camera 130 is a lens interchangeable single-lens reflex type camera, and includes a camera main body portion (camera body) 131, an imaging lens unit 132, a grip portion 133, a monitor 134, and an electronic viewfinder 135. The imaging lens unit 312 is an interchangeable lens unit, and is provided near substantially the center of the front surface of the camera main body portion 311. The grip portion 133 is provided on the left side of the front surface of the camera main body portion 311, and a camera operator grips the grip portion 133. The monitor 134 is provided on the left side of substantially the center of the back surface of the camera main body portion 131. The electronic viewfinder 135 is provided on the upper part of the monitor 14 on the back surface of the camera main body portion 131. By looking into the electronic viewfinder 135, the camera operator can visually recognize the optical image of the subject guided from the imaging lens unit 132 and determine the composition. The technology according to the above embodiment and the like can be applied to the electronic viewfinder 135.

### Application Example 4

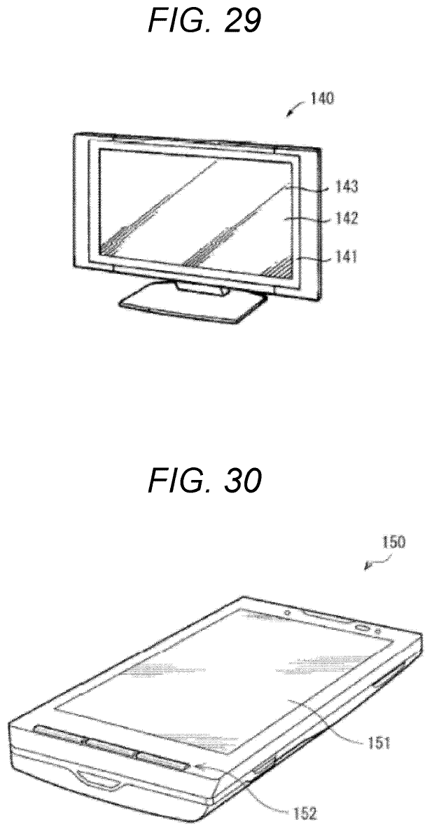

FIG. 29 represents an example of an external appearance of a television apparatus 140. The television apparatus 140 includes a video display screen section 141 including a front panel 142 and a filter glass 143. The technology according to the above embodiment and the like can be applied to the video display screen section 141.

### Application Example 5

FIG. 30 represents an example of an external appearance of a smartphone 150. The smartphone 150 includes a display section 151 that displays various types of information, and an operation section 152 including a button or the like that receives an operation input by the user. The technology according to the above embodiment and the like can be applied to the display section 151.

### Application Example 6

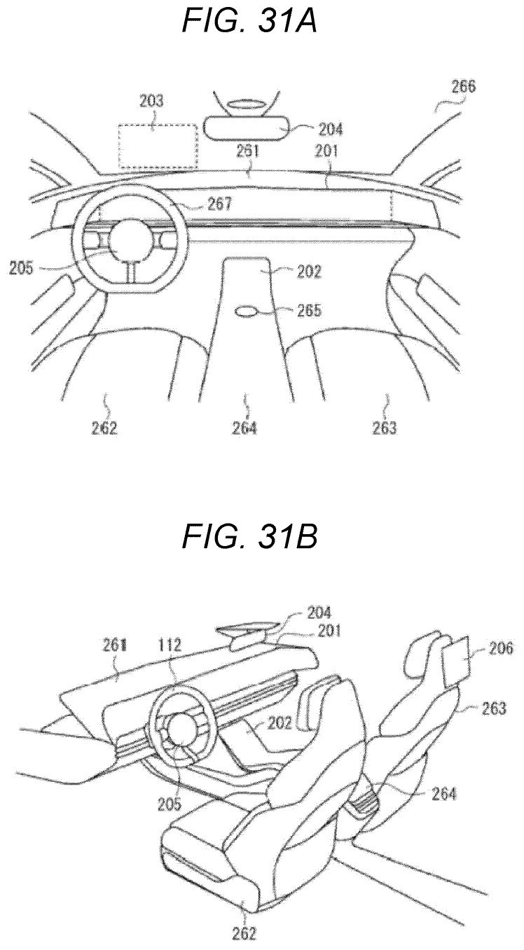

FIGS. 31A and 31B represent a configuration example of a vehicle to which the technology of the present disclosure is applied, FIG. 31A illustrates an example of the inside of a vehicle as viewed from the rear portion of a vehicle 200, and FIG. 31B illustrates an example of the inside of the vehicle as viewed from the left rear of the vehicle 200.

The vehicle of FIGS. 31A and 31B includes a center display 201, a console display 202, a head-up display 203, a digital rear mirror 204, a steering wheel display 205, and a rear entertainment display 106.

The center display 201 is disposed on a dashboard 261 at a position facing a driver's seat 262 and a passenger seat 263. FIG. 31A illustrates an example of the center display 201 having a horizontally long shape extending from the driver's seat 262 side to the passenger seat 263 side, but the screen size and the arrangement location of the center display 201 are not limited thereto. The center display 201 can display information detected by various sensors. As a specific example, the center display 201 can display a captured image captured by the image sensor, a distance image to an obstacle in front of or on a side of the vehicle measured by the ToF sensor, a body temperature of the occupant detected by the infrared sensor, and the like. The center display 201 can be used to display, for example, at least one of safety-related information, operation-related information, a life log, health-related information, authentication/identification-related information, or entertainment-related information.

The safety-related information is information such as doze detection, looking-away detection, mischief detection of a child riding together, presence or absence of wearing a seat belt, and detection of leaving of an occupant based on a detection result of the sensor. The operation-related information is gesture information regarding the operation of the occupant detected using the sensor. The gesture may include operations of various facilities in the vehicle, for example, operations of an air conditioning equipment, a navigation device, an audio visual (AV) device, a lighting device, and the like. The lifelogs include lifelogs of all the occupants. For example, the life log includes an action record of each occupant. By acquiring and storing the life log, it is possible to confirm the state of the occupant when the accident occurs. The health-related information includes the body temperature of the occupant detected using the temperature sensor and information on the health condition of the occupant estimated on the basis of the detected body temperature. Alternatively, the information on the health condition of the occupant may be estimated on the basis of the face of the occupant captured by the image sensor. Furthermore, the information on the health condition of the occupant may be estimated on the basis of an answer content of the occupant obtained by talking with the occupant using the automatic voice. The authentication/identification-related information includes information such as a keyless entry function for performing face authentication using a sensor and an automatic adjustment function of a seat height and a position in face identification. The entertainment-related information includes operation information of the AV device by the occupant detected by the sensor, information of content suitable for the occupant detected and recognized by the sensor, and the like.

The console display 202 can be used to display the life log information, for example. The console display 202 is disposed near the shift lever 265 in the center console 264 between the driver's seat 262 and the passenger seat 263. The console display 202 can also display information detected by various sensors. Furthermore, the console display 202 may display an image of the periphery of the vehicle captured by the image sensor, or may display a distance image to an obstacle in the periphery of the vehicle.

The head-up display 203 is virtually displayed behind a windshield 266 in front of the driver's seat 262. The head-up display 203 can be used to display, for example, at least one of the safety-related information, the operation-related information, the life log, the health-related information, the authentication/identification-related information, or the entertainment-related information. Since the head-up display 203 is often virtually arranged in front of the driver's seat 262, it is suitable for displaying information directly related to the operation of the vehicle, such as the speed of the vehicle, the remaining amount of fuel, and the remaining amount of the battery.

The digital rear mirror 204 can display not only the rear of the vehicle but also the state of the occupant in the rear seat, and thus can be used to display the life log information of the occupant in the rear seat, for example.

The steering wheel display 205 is disposed near the center of a steering wheel 267 of the vehicle. The steering wheel display 205 can be used to display, for example, at least one of the safety-related information, the operation-related information, the life log, the health-related information, the authentication/identification-related information, or the entertainment-related information. In particular, because the steering wheel display 205 is close to the driver's hand, the steering wheel display 205 is suitable for displaying the life log information such as a body temperature of the driver, or for displaying information regarding an operation of the AV device, air conditioning equipment, or the like.

The rear entertainment display 206 is attached to the back side of the driver's seat 262 and the passenger seat 263, and is for viewing by an occupant in the rear seat. The rear entertainment display 206 can be used to display, for example, at least one of the safety-related information, the operation-related information, the life log, the health-related information, the authentication/identification-related information, or the entertainment-related information. In particular, because the rear entertainment display 206 is in front of the occupant in the rear seat, information related to the occupant in the rear seat is displayed. The rear entertainment display 206 may display, for example, information regarding the operation of an AV device or air conditioning equipment, or may display a result of measuring a body temperature or the like of the occupant in the rear seat by a temperature sensor.

The technology according to the above embodiment and the like can be applied to the center display 201, the console display 202, the head-up display 203, the digital rear mirror 204, the steering wheel display 205, and the rear entertainment display 206.

Note that the present technology can have the following configurations.
(1) A display device including:
a pixel including a light emitting element;
a plurality of signal lines each of which is connected to a plurality of the pixels; and
a signal line drive section including a reference voltage generation section that generates a reference voltage whose voltage level changes with time, the signal line drive section supplying the reference voltage to the plurality of signal lines to offset a fluctuation in a voltage of one end of the light emitting element due to a change in a voltage of each of the signal lines.
(2) The display device according to (1), in which the signal line drive section supplies the reference voltage to the plurality of signal lines such that an average value of fluctuations in a voltage at one end of the light emitting element due to a change in a voltage of each of the signal lines decreases every first predetermined period.
(3) The display device according to (1) or (2), in which the reference voltage generation section generates an offset voltage whose voltage level changes with time, and generates the reference voltage after generating the offset voltage, and
the offset voltage and the reference voltage change with time in directions opposite to each other.
(4) The display device according to (1) or (2), in which the signal line drive section supplies a precharge voltage at which a voltage level of each of the signal lines becomes a first level, supplies an offset voltage whose voltage level changes with time after supply of the precharge voltage, and generates the reference voltage after generation of the offset voltage,
the offset voltage and the reference voltage change with time in the same direction, and
the signal line drive section extends a period from start of supply of the precharge voltage to start of supply of the offset voltage.
(5) The display device according to (4), in which the signal line drive section maintains a voltage of each of the signal lines at the first level for a second predetermined period from when the voltage of the signal line becomes the first level to when the offset voltage is supplied.
(6) The display device according to (5), in which the reference voltage generation section delays start of generation of the offset voltage.
(7) The display device according to (5), in which the signal line drive section includes a voltage maintenance section that maintains a voltage of each of the signal lines at the first level for a second predetermined period from when the voltage of the signal line becomes the first level to when the offset voltage is supplied.
(8) The display device according to (4), in which the signal line drive section slows a change in the precharge voltage.
(9) The display device according to (8), in which the reference voltage generation section generates the precharge voltage that changes slower than a predetermined speed.
(10) The display device according to (8), in which the signal line drive section includes a delay section that slows a change in the precharge voltage.
(11) The display device according to (1) or (2), in which the reference voltage generation section generates the reference voltage that changes in a reverse direction every third predetermined period.
(12) The display device according to (11), in which the third predetermined period includes one horizontal period.
(13) The display device according to (11) or (12), in which the reference voltage generation section generates an offset voltage whose voltage level changes with time, and generates the reference voltage after generation of the offset voltage, and
the offset voltage and the reference voltage change with time in the same direction.
(14) The display device according to (1) or (2), in which the signal line drive section slows a change in a voltage of each of the signal lines up to a second level that is a voltage level at start of supply of the reference voltage.
(15) The display device according to (1), in which the reference voltage generation section generates an offset voltage whose voltage level changes with time, and generates the reference voltage after generation of the offset voltage, and
before generation of the offset voltage, the reference voltage generation section generates a voltage that brings a voltage level of each of the signal lines to a third level that is a voltage level substantially same as a voltage at an end of a change of the reference voltage.
(16) The display device according to any one of (1) to (15), in which a voltage at one end of the light emitting element fluctuates due to a change in a voltage of each of the signal lines via a parasitic capacitance between the signal line and the one end of the light emitting element.
(17) The display device according to any one of (1) to (16), in which the signal line drive section further includes a plurality of switches connected between the reference voltage generation section and each of the plurality of signal lines, and
the switches are turned on or off at timing according to a luminance value of the pixel.

Aspects of the present disclosure are not limited to the above-described individual embodiments, but include various modifications that can be conceived by those skilled in the art, and the effects of the present disclosure are not limited to the above-described contents. That is, various additions, modifications, and partial deletions are possible without departing from the conceptual idea and spirit of the present disclosure derived from the matters defined in the claims and equivalents thereof.

### REFERENCE SIGNS LIST

1 Display device
4 Signal line drive section
41 Ramp wave generation circuit
42 Switch
43 Voltage maintenance section
44 Delay section
8 Pixel
11 Pixel circuit
12 OLED
Cp Parasitic capacitance
SIG Signal line

1. A display device comprising:
a pixel including a light emitting element;
a plurality of signal lines each of which is connected to a plurality of the pixels; and
a signal line drive section including a reference voltage generation section that generates a reference voltage whose voltage level changes with time, the signal line drive section supplying the reference voltage to the plurality of signal lines to offset a fluctuation in a voltage of one end of the light emitting element due to a change in a voltage of each of the signal lines.

2. The display device according to claim 1, wherein the signal line drive section supplies the reference voltage to the plurality of signal lines such that an average value of fluctuations in a voltage at one end of the light emitting element due to a change in a voltage of each of the signal lines decreases every first predetermined period.

3. The display device according to claim 1, wherein the reference voltage generation section generates an offset voltage whose voltage level changes with time, and generates the reference voltage after generating the offset voltage, and
the offset voltage and the reference voltage change with time in directions opposite to each other.

4. The display device according to claim 1, wherein the signal line drive section supplies a precharge voltage at which a voltage level of each of the signal lines becomes a first level, supplies an offset voltage whose voltage level changes with time after supply of the precharge voltage, and generates the reference voltage after generation of the offset voltage,
the offset voltage and the reference voltage change with time in a same direction, and
the signal line drive section extends a period from start of supply of the precharge voltage to start of supply of the offset voltage.

5. The display device according to claim 4, wherein the signal line drive section maintains a voltage of each of the signal lines at the first level for a second predetermined period from when the voltage of the signal line becomes the first level to when the offset voltage is supplied.

6. The display device according to claim 5, wherein the reference voltage generation section delays start of generation of the offset voltage.

7. The display device according to claim 5, wherein the signal line drive section includes a voltage maintenance section that maintains a voltage of each of the signal lines at the first level for a second predetermined period from when the voltage of the signal line becomes the first level to when the offset voltage is supplied.

8. The display device according to claim 4, wherein the signal line drive section slows a change in the precharge voltage.

9. The display device according to claim 8, wherein the reference voltage generation section generates the precharge voltage that changes slower than a predetermined speed.

10. The display device according to claim 8, wherein the signal line drive section includes a delay section that slows a change in the precharge voltage.

11. The display device according to claim 1, wherein the reference voltage generation section generates the reference voltage that changes in a reverse direction every third predetermined period.

12. The display device according to claim 11, wherein the third predetermined period includes one horizontal period.

13. The display device according to claim 11, wherein the reference voltage generation section generates an offset voltage whose voltage level changes with time, and generates the reference voltage after generation of the offset voltage, and
the offset voltage and the reference voltage change with time in a same direction.

14. The display device according to claim 1, wherein the signal line drive section slows a change in a voltage of each of the signal lines up to a second level that is a voltage level at start of supply of the reference voltage.

15. The display device according to claim 1, wherein the reference voltage generation section generates an offset voltage whose voltage level changes with time, and generates the reference voltage after generation of the offset voltage, and
before generation of the offset voltage, the reference voltage generation section generates a voltage that brings a voltage level of each of the signal lines to a third level that is a voltage level substantially same as a voltage at an end of a change of the reference voltage.

16. The display device according to claim 1, wherein a voltage at one end of the light emitting element fluctuates due to a change in a voltage of each of the signal lines via a parasitic capacitance between the signal line and the one end of the light emitting element.

17. The display device according to claim 1, wherein the signal line drive section further includes a plurality of switches connected between the reference voltage generation section and each of the plurality of signal lines, and
the switches are turned on or off at timing according to a luminance value of the pixel.
